(19) United States
(12) Patent Application Publication
(10) Pub. No.: US 2025/0162161 A1
(43) Pub. Date: May 22, 2025

(54) DATA PROCESSING METHOD AND APPARATUS, DEVICE, AND COMPUTER MEDIUM

(71) Applicant: Beijing Youzhuju Network Technology Co., Ltd., Pinggu District (CN)

(72) Inventors: Yifeng LI, Beijing (CN); Hanbo ZHANG, Beijing (CN); Jie XU, Beijing (CN); Tao KONG, Beijing (CN)

(21) Appl. No.: 18/920,347

(22) Filed: Oct. 18, 2024

(30) Foreign Application Priority Data
Nov. 21, 2023 (CN) 202311562350.2

(51) Int. Cl. B25J 9/16; G06V 10/26; G06V 10/70; G06V 20/50

(52) U.S. Cl. CPC B25J 9/1697; G06V 10/26; G06V 10/70; G06V 20/50; G06V 2201/07

(57) ABSTRACT

The present disclosure discloses a data processing method and apparatus, a device, and a computer medium. The method includes: obtaining an instruction from a user and an environment image; determining, based on the instruction, the environment image and a preset target interaction model, an object to be grabbed in the environment image that corresponds to the instruction; and controlling a grabbing apparatus to grab a target item corresponding to the object to be grabbed.

### CROSS-REFERENCE TO RELATED APPLICATIONS

The present disclosure is based on and claims priority to China Patent Application No. 202311562350.2 filed on Nov. 21, 2023, the disclosure of which is incorporated by reference herein in its entirety.

### TECHNICAL FIELD

The present disclosure belongs to the field of intelligent control, and in particular, to a data processing method and apparatus, a device, and a computer medium.

### BACKGROUND

In the related art, with the development of technologies related to intelligent robots, intelligent robots are used more and more widely. Grabbing is an important capability of an intelligent robot.

### SUMMARY

Embodiments of the present disclosure provide an implementation solution that is different from that in the related art, to solve the technical problem in the related art.

According to a first aspect, the present disclosure provides a data processing method, the method comprising:
obtaining an instruction from a user and an environment image;
determining, based on the instruction, the environment image and a preset target interaction model, an object to be grabbed in the environment image that corresponds to the instruction; and
controlling a grabbing apparatus to grab a target item corresponding to the object to be grabbed.

According to a second aspect, the present disclosure provides a data processing apparatus, comprising:
an obtaining unit, configured to obtain an instruction from a user and an environment image;
a determining unit, configured to determine, based on the instruction, the environment image and a preset target interaction model, an object to be grabbed in the environment image that corresponds to the instruction; and
a control unit, configured to control a grabbing apparatus to grab a target item corresponding to the object to be grabbed.

According to a third aspect, the present disclosure provides an electronic device, comprising:
a processor; and
a memory, configured to store executable instructions of the processor,
wherein the processor is configured to execute the method according to the first aspect or any one of possible implementations of the first aspect by executing the executable instructions.

According to a fourth aspect, an embodiment of the present disclosure provides a computer-readable storage medium, having a computer program stored thereon, wherein when the computer program is executed by a processor, the method according to the first aspect or any one of possible implementations of the first aspect is implemented.

### BRIEF DESCRIPTION OF THE DRAWINGS

In order to more clearly describe the technical solutions in the embodiments of the present disclosure or the related art, the accompanying drawings for describing the embodiments or the related art will be briefly described below. It is clear that the accompanying drawings in the following description show some embodiments of the present disclosure, and a person of ordinary skill in the art may still derive other drawings from these accompanying drawings without creative efforts. In the drawings:

FIG. 1 is a schematic diagram of a structure of a system according to an embodiment of the present disclosure;

FIG. 2a is a schematic flowchart of a data processing method according to an embodiment of the present disclosure;

FIG. 2b is a schematic diagram of a scenario of the data processing method according to an embodiment of the present disclosure;

FIG. 3 is a schematic diagram of a structure of a data processing apparatus according to an embodiment of the present disclosure; and

FIG. 4 is a schematic diagram of a structure of an electronic device according to an embodiment of the present disclosure.

### DETAILED DESCRIPTION

Embodiments of the present disclosure are described in detail below, and examples of the embodiments are shown in the accompanying drawings. The embodiments described with reference to the accompanying drawings are exemplary, and are intended to explain the present disclosure, but should not be construed as limiting the present disclosure.

The terms “first” and “second” in the specification, claims, and accompanying drawings of the embodiments of the present disclosure are used to distinguish similar objects, and are not necessarily used to describe a specific sequence or sequence of precedence. It should be understood that the data named in such a way is interchangeable in proper circumstances so that the embodiments of the embodiments of the present disclosure described herein can be implemented, for example, in an order other than those illustrated or described herein. In addition, the terms “include” and “have” and any variations thereof are intended to cover non-exclusive inclusion. For example, a process, method, system, product, or device that includes a series of steps or units is not necessarily limited to those steps or units that are clearly listed, but may include other steps or units that are not clearly listed or inherent to these processes, methods, products, or devices.

First, some terms in the embodiments of the present disclosure are explained below to facilitate those skilled in the art to understand.

An interactive visual semantic disambiguation (IVSD) dialogue refers to solving a semantic ambiguity problem in visual information through interaction between a person and a machine. Generally, the IVSD dialogue uses an interaction manner based on a natural language to allow a human user to have a dialogue with the machine, and to provide additional information or explanations for the machine in a natural language manner, to help the machine better understand semantic information in an image.

The inventors have found through research that in the related art, with the development of technologies related to intelligent robots, intelligent robots are used more and more widely. Grabbing is an important capability of an intelligent robot. In the related art, when an intelligent robot grabs an item, the intelligent robot cannot accurately identify a corresponding target item based on an instruction from a user, resulting in low grabbing efficiency.

In addition, when an intelligent robot performs a corresponding task based on an instruction from a user, the robot locates a target related to the task based on interactive content with the user, and performs the task based on the interactive content. This manner requires high understanding capability of the intelligent robot, and the intelligent robot cannot accurately locate a target based on the interactive content with the user, resulting in low accuracy of task execution.

In addition, the robot has weak interactive visual semantic disambiguation capability, and the intelligent robot cannot accurately understand a surrounding scene or analyze a target in the scene, which will affect the accuracy of task execution by the intelligent robot.

Embodiments of the present disclosure provide an implementation solution that is different from that in the related art, to solve the technical problem in the related art that an intelligent robot cannot accurately identify a corresponding target item based on an instruction from a user, resulting in low grabbing efficiency.

In the solution of obtaining an instruction from a user and an environment image, determining, based on the instruction, the environment image and a preset target interaction model, an object to be grabbed in the environment image that corresponds to the instruction, and controlling a grabbing apparatus to grab a target item corresponding to the object to be grabbed, provided in the present disclosure, the environment image and the instruction can be analyzed in real time by using the preset target interaction model, and a new algorithm, i.e., the target interaction model, and the analysis of the environment image are introduced. Therefore, when an intelligent robot grabs an item, the intelligent robot can accurately identify a corresponding target item based on an instruction from a user, and the grabbing efficiency is high.

The following uses specific embodiments to describe in detail the technical solutions of the present disclosure and how the technical solutions of the present disclosure solve the above technical problems. The following specific embodiments may be combined with each other, and for the same or similar concepts or processes, some embodiments may not be described again. The embodiments of the present disclosure will be described below with reference to the accompanying drawings.

FIG. 1 is a schematic diagram of a structure of a system according to an exemplary embodiment of the present disclosure. The system includes a model training device 10 and an intelligent robot 11, where
the intelligent robot 11 may be configured to: obtain an instruction from a user and an environment image; determine, based on the instruction, the environment image, and a preset target interaction model, an object to be grabbed in the environment image that corresponds to the instruction; and control a grabbing apparatus to grab a target item corresponding to the object to be grabbed.

The model training device 10 may be configured to:
obtain a sample task;
obtain, based on a type of the sample task, corresponding sample interactive information and a sample image corresponding to the sample interactive information, wherein the sample interactive information includes: sample interactive content and a sample task execution result;
perform word processing on the sample task and the sample interactive content by using an initial word processing unit in an initial interaction model, to obtain a corresponding word vector sequence;
encode the sample image by using an initial visual encoding unit in the initial interaction model, to obtain an image feature sequence corresponding to the sample image;
analyze the word vector sequence and the image feature sequence by using an initial transformation model in the initial interaction model, to obtain a corresponding task prediction result; and
train the initial interaction model based on the sample task execution result and the task prediction result, to obtain the target interaction model.

Optionally, the foregoing target interaction model may also be obtained through training by the intelligent robot 11.

An execution principle and an interaction process of each component unit in the system embodiment, for example, the model training device 10 and the intelligent robot 11, may be referred to the description of the following method embodiments.

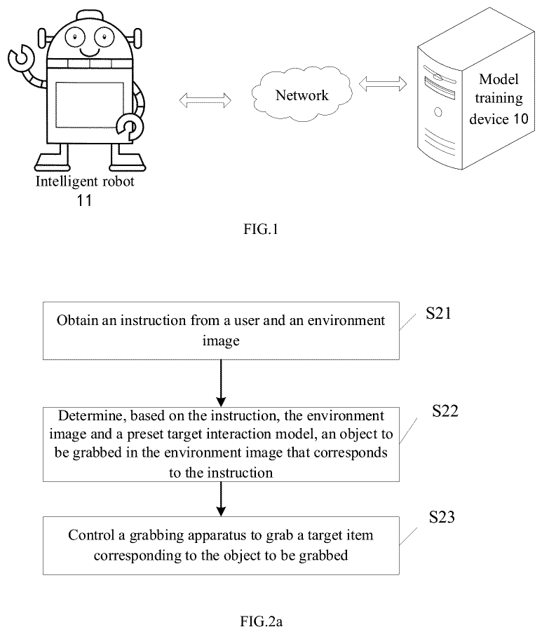

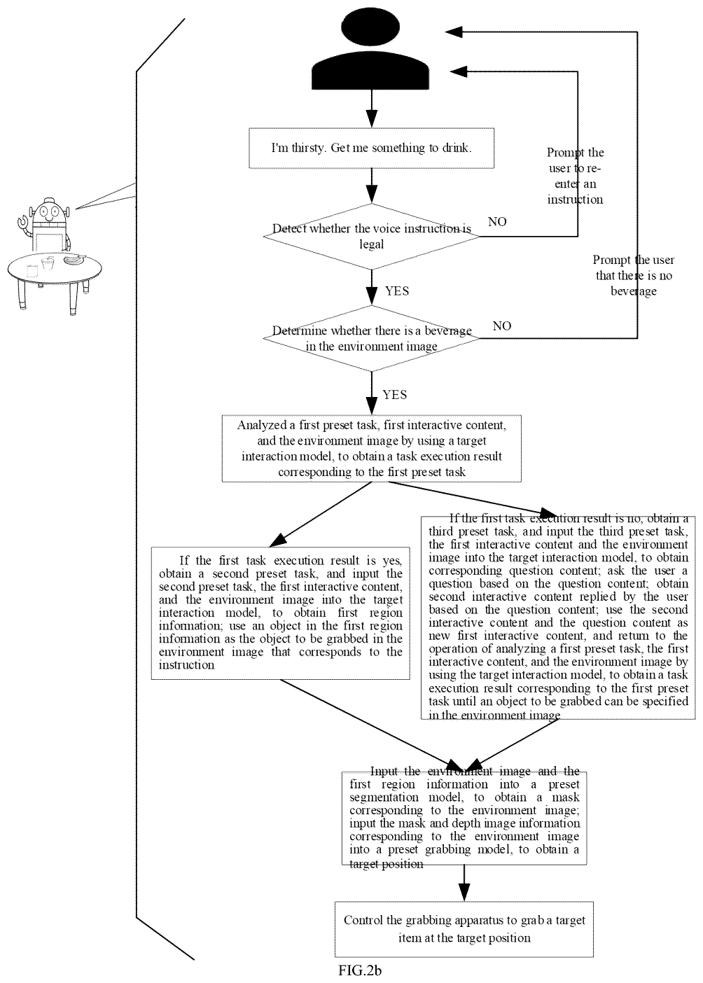

FIG. 2a is a schematic flowchart of a data processing method according to an exemplary embodiment of the present disclosure. The method may be performed by the foregoing intelligent robot or another device with a moving function and a grabbing function. The intelligent robot has the moving function and the grabbing function. The method includes at least the following steps S21 to S23.

At S21, an instruction from a user and an environment image are obtained.

In some optional embodiments of the present application, the instruction from the user may be an instruction of any one of the following types: a voice instruction, a gesture instruction, and an instruction triggered through an interactive screen. The interactive screen may be a screen of the intelligent robot, or may be a screen of a terminal device used by the user. The terminal device may include: a mobile phone, a computer, and the like. When the interactive screen is a screen of the terminal device, the terminal device may send the instruction to the intelligent robot.

Optionally, the foregoing environment image is acquired by using a photographing apparatus of the intelligent robot, and the instruction from the user and the environment image are acquired at a same moment.

At S22, an object to be grabbed in the environment image that corresponds to the instruction is determined based on the instruction, the environment image, and a preset target interaction model.

In some optional embodiments of the present application, the instruction from the user is first interactive content of the user. In the foregoing S22, the determining, based on the instruction, the environment image, and a preset target interaction model, an object to be grabbed in the environment image that corresponds to the instruction includes the following operations S221 and S222.

At S221, a first preset task, the first interactive content, and the environment image are analyzed by using the target interaction model, to obtain a task execution result corresponding to the first preset task, where the first preset task is a task of determining, based on the first interactive content, whether the object to be grabbed can be specified in the environment image.

Specifically, in the foregoing S221, the analyzing a first preset task, the first interactive content, and the environment image by using the target interaction model, to obtain a task execution result corresponding to the first preset task includes: inputting the first preset task, the first interactive content, and the environment image into the target interaction model, to obtain the task execution result corresponding to the first preset task.

At S222, the object to be grabbed in the environment image that corresponds to the instruction is determined based on the task execution result.

In some optional embodiments of the present application, the determining, based on the task execution result, the object to be grabbed in the environment image that corresponds to the instruction in the foregoing S222 includes the following operations S2221 to S2223.

At S2221, if the task execution result is yes, a second preset task is obtained, where a task type of the second preset task is a task of specifying, based on the first interactive content, first region information of an image region occupied by the object to be grabbed in the environment image.

At S2222, the second preset task, the first interactive content, and the environment image are input into the target interaction model, to obtain the first region information.

At S2223, an object in the first region information is used as the object to be grabbed in the environment image that corresponds to the instruction.

In some optional embodiments of the present application, the method further includes the following operations S01 to S05.

At S01, if the task execution result is no, a third preset task is obtained, where a task type of the third preset task is a task of asking a corresponding question based on the first interactive content.

At S02, the third preset task, the first interactive content, and the environment image are input into the target interaction model, to obtain corresponding question content.

At S03, the user is asked a question based on the question content.

According to this solution, disambiguation may be performed on the interactive content.

At S04, second interactive content replied by the user based on the question content is obtained.

At S05, the second interactive content and the question content are used as new first interactive content, and the operation of analyzing a first preset task, the first interactive content, and the environment image by using the target interaction model, to obtain a task execution result corresponding to the first preset task is returned until an object to be grabbed can be specified in the environment image.

At S23, the grabbing apparatus is controlled to grab the target item corresponding to the object to be grabbed.

In some optional embodiments of the present application, in the foregoing S23, the controlling the grabbing apparatus to grab the target item corresponding to the object to be grabbed includes the following operations S2031 and S2032.

At S2031, the grabbing apparatus is controlled to move to a target position where the target item corresponding to the object to be grabbed is located.

At S2032, the grabbing apparatus is controlled to grab the target item at the target position.

In some optional embodiments of the present application, the method further includes the following operations S1 and S2.

At S1, the environment image and the first region information are input into a preset segmentation model, to obtain a mask corresponding to the environment image.

The segmentation model may be implemented by using Segment anything.

In the foregoing mask, mask information corresponding to the first region information in the environment image is 1, and mask information corresponding to an image region other than the first region information in the environment image is 0.

At S2, the mask and depth image information corresponding to the environment image are input into a preset grabbing model, to obtain the target position. The target position may specifically include pose information. The pose information may be a stable and collision-free grabbing pose.

In some embodiments, the foregoing grabbing model may output a plurality of alternative positions. In this case, the foregoing method further includes: determining a target position from the plurality of alternative positions. The determining a target position from the plurality of alternative positions may include: selecting, from the alternative positions, a target position that is closest to the target item.

The grabbing model may be implemented by using ContactGraspNet or ContactGraspNet.

Optionally, the grabbing apparatus may be a mechanical arm, and the target position may be a position of the object to be grabbed in the real world.

In some optional embodiments of the present application, the method further includes: performing legality detection on the first interactive content, and if it is determined that the first interactive content is legal, determining to perform the operation of analyzing a first preset task, the first interactive content, and the environment image by using the target interaction model, to obtain a task execution result corresponding to the first preset task.

Optionally, semantic legality analysis may be performed on the first interactive content by using ChatGPT. If the semantics is not clear, it is determined that the first interactive content is illegal. If the semantics of the first interactive content is clear, it is determined that the first interactive content is legal.

After it is determined that the first interactive content is illegal, the user may be prompted to re-enter an instruction.

In some optional embodiments of the present application, after it is determined that the first interactive content is legal, the method further includes: detecting, based on a preset detection model, whether the environment image contains an alternative object that is of a same category as an object corresponding to the first interactive content, and if yes, determining to perform the operation of analyzing a first preset task, the first interactive content, and the environment image by using the target interaction model, to obtain a task execution result corresponding to the first preset task.

In some optional embodiments of the present application, the alternative object being of the same category as the object corresponding to the first interactive content includes: the alternative object being of a category to which the object corresponding to the first interactive content belongs. For example, if the object corresponding to the first interactive content is a beverage, the alternative object may be cola, mineral water, or the like.

Optionally, the foregoing detection model may be a model obtained through machine learning and training.

In some optional embodiments of the present application, the foregoing detection model may be a preset large-scale pre-trained vision-language model, and the foregoing environment image may be acquired by using an rgb-d depth camera. If it is determined that the environment image does not contain an alternative object that is of a same category as the object corresponding to the first interactive content, the user may be directly prompted that there is no object corresponding to the first interactive content.

In some optional embodiments of the present application, the method further includes the following operations S201 to S206.

At S201, a sample task is obtained.

In some optional embodiments of the present application, the sample task is any one of the following tasks: a task of answering a question raised by a questioner, a task of asking a corresponding question based on interactive content with a responder, a task of specifying, based on interactive content with the questioner or the responder, second region information of an image region occupied by a target object corresponding to the interactive content in a sample image, a task of answering, based on interactive content with the questioner or the responder, whether the target object corresponding to the interactive content can be specified in the sample image, and a task of describing the sample image.

In some optional embodiments of the present application, the task of answering a question raised by a questioner may include: a task of answering a question raised by a questioner based on a sample image. Specifically, the task may include: a task of answering a question raised by a questioner based on a preset region in the sample image.

In some optional embodiments, the sample task may be text information or voice information, or may be instruction information triggered through an interactive screen.

At S202, corresponding sample interactive information and a sample image corresponding to the sample interactive information are obtained based on a type of the sample task, wherein the sample interactive information includes: sample interactive content and a sample task execution result.

In some optional embodiments of the present application, the sample interactive information may include interactive information between a plurality of roles, for example, a plurality of pieces of dialogue information. A piece of dialogue information may specifically include a role name of a role and dialogue content of the role to an opposite role. The dialogue content may include: text information and/or voice information.

In some embodiments of the present application, in the sample interactive information, the sample interactive content is located before the sample task execution result, and the sample interactive content is adjacent to the sample task execution result. Both the sample interactive content and the sample task execution result are dialogue information.

In some optional embodiments of the present application, in the foregoing S202, the obtaining corresponding sample interactive information based on a type of the sample task includes the following operations S2021 to S2023.

At S2021, an interactive role corresponding to the type of the sample task is determined based on the type of the sample task, wherein the interactive role is a questioner or a responder.

In some optional embodiments of the present application, in the foregoing S2021, the determining an interactive role corresponding to the type of the sample task based on the type of the sample task may include: determining the interactive role corresponding to the type of the sample task based on a preset correspondence. The preset correspondence may store a correspondence between different types of sample tasks and corresponding interactive roles.

In some optional embodiments of the present application, if the type of the sample task is a task of answering a question raised by a questioner, the interactive role corresponding to the type of the sample task is a responder.

In some optional embodiments of the present application, if the type of the sample task is a task of asking a corresponding question based on interactive content with a responder, the interactive role corresponding to the type of the sample task is a questioner.

In some optional embodiments of the present application, if the type of the sample task is a task of specifying, based on interactive content with a questioner, second region information of an image region occupied by a target object corresponding to the interactive content in a sample image, the interactive role corresponding to the type of the sample task is a responder.

In some optional embodiments of the present application, if the type of the sample task is a task of specifying, based on interactive content with a responder, second region information of an image region occupied by a target object corresponding to the interactive content in a sample image, the interactive role corresponding to the type of the sample task is a questioner.

In some optional embodiments of the present application, if the type of the sample task is a task of answering, based on interactive content with a questioner, whether the target object corresponding to the interactive content can be specified in the sample image, the interactive role corresponding to the type of the sample task is a responder.

In some optional embodiments of the present application, if the type of the sample task is a task of answering, based on interactive content with a responder, whether the target object corresponding to the interactive content can be specified in the sample image, the interactive role corresponding to the type of the sample task is a questioner.

In some optional embodiments of the present application, if the type of the sample task is a task of describing the sample image, the interactive role corresponding to the type of the sample task is a responder or a questioner.

At S2022, a sample task execution result is determined from a target sample interactive information set based on the interactive role.

Optionally, a sample interactive information base may include a plurality of sample interactive information sets, and each sample interactive information set may be considered as a group of pieces of dialogue information. Each group of pieces of dialogue information may include a plurality of pieces of dialogue information. The target sample interactive information set is a sample interactive information set in the sample interactive information base that corresponds to the type of the sample task.

Optionally, the foregoing method further includes: obtaining the plurality of sample interactive information sets; and determining the target sample interactive information set corresponding to the type of the sample task from the plurality of sample interactive information sets. Specifically, each type of sample task corresponds to one sample interactive information set.

In some optional embodiments of the present application, in the foregoing S2022, the determining a sample task execution result from a target sample interactive information set based on an interactive role includes: randomly selecting dialogue content of the interactive role to an opposite role from the target sample interactive information set; and using the dialogue content as the sample task execution result.

In some other optional embodiments of the present application, in the foregoing S2022, the determining a sample task execution result from a target sample interactive information set based on an interactive role includes: determining the sample task execution result from the target sample interactive information set based on the interactive role and the type of the sample task.

Optionally, the determining the sample task execution result from the target sample interactive information set based on the interactive role and the type of the sample task includes: if the type of the sample task is a task of answering a question raised by a questioner, using, as the sample task execution result, dialogue content of the interactive role whose previous piece of dialogue content is question dialogue content of the opposite role in the target sample interactive information set, where the dialogue content of the interactive role is a declarative sentence.

Optionally, the determining the sample task execution result from the target sample interactive information set based on the interactive role and the type of the sample task includes: if the type of the sample task is a task of asking a corresponding question based on interactive content with a responder, using, as the sample task execution result, dialogue content of the interactive role whose previous piece of dialogue content is dialogue content of the opposite role in the target sample interactive information set, where the dialogue content of the interactive role is a question.

Optionally, the determining the sample task execution result from the target sample interactive information set based on the interactive role and the type of the sample task includes: if the type of the sample task is a task of specifying, based on interactive content with the questioner or the responder, second region information of an image region occupied by a target object corresponding to the interactive content in the sample image, using, as the sample task execution result, dialogue content of the interactive role whose previous piece of dialogue content is dialogue content of the opposite role in the target sample interactive information set, where the dialogue content of the interactive role includes region information.

At S2023, dialogue content before the sample task execution result in the target sample interactive information set is used as the sample interactive content.

In some optional embodiments of the present application, the target sample interactive information set includes a group of pieces of dialogue information.

Optionally, the group of pieces of dialogue information referred to in the present application means dialogue information in which a target object is clear and unambiguous at the end of a dialogue.

In some other optional embodiments of the present application, the target sample interactive information set may include a plurality of groups of pieces of dialogue information. In the foregoing S2023, the dialogue content before the sample task execution result in the target sample interactive information set is used as the sample interactive content, including: using, as the sample interactive content, dialogue content before the sample task execution result in any one of the groups of pieces of dialogue information in the target sample interactive information set.

If the type of the sample task is a task of answering, based on interactive content with the questioner or the responder, whether the target object corresponding to the interactive content can be specified in the sample image, the obtaining corresponding sample interactive information based on the type of the sample task includes the following operations S01 to S03.

At S01, an interactive role corresponding to the type of the sample task is determined based on the type of the sample task, wherein the interactive role is a questioner or a responder.

If the type of the sample task is a task of answering, based on interactive content with the questioner, whether the target object corresponding to the interactive content can be specified in the sample image, the interactive role corresponding to the type of the sample task is a responder.

If the type of the sample task is a task of answering, based on interactive content with the responder, whether the target object corresponding to the interactive content can be specified in the sample image, the interactive role corresponding to the type of the sample task is a questioner.

At S02, a preset sample task execution result is obtained, where the preset sample task execution result is yes or no.

At S03, if the sample task execution result is yes and the target sample interactive information set includes only one group of pieces of dialogue information, all the dialogue content in the target sample interactive information set is used as the sample interactive content; if the sample task execution result is no and the target sample interactive information set includes only one group of pieces of dialogue information, some of the dialogue content in the target sample interactive information set is used as the sample interactive content; if the sample task execution result is yes and the target sample interactive information set includes a plurality of groups of pieces of dialogue information, all the dialogue content in any one of the groups of pieces of dialogue information in the target sample interactive information set is used as the sample interactive content; and if the sample task execution result is no and the target sample interactive information set includes a plurality of groups of pieces of dialogue information, some of the dialogue content in any one of the groups of pieces of dialogue information in the target sample interactive information set is used as the sample interactive content.

At S203, the sample task and the sample interactive content are processed by using an initial word processing unit in an initial interaction model, to obtain a corresponding word vector sequence.

At S204, the sample image is encoded by using an initial visual encoding unit in the initial interaction model, to obtain an image feature sequence corresponding to the sample image.

At S205, the word vector sequence and the image feature sequence are analyzed by using an initial transformation model in the initial interaction model, to obtain a corresponding task prediction result.

At S206, the initial interaction model is trained based on the sample task execution result and the task prediction result, to obtain a target interaction model.

Optionally, the target interaction model is configured to: interact with an interactive object based on first interactive content and an environment image of the interactive object. The interactive object may refer to a user.

In some optional embodiments of the present application, in the foregoing S206, the training the initial interaction model based on the sample task execution result and the task prediction result, to obtain the target interaction model includes the following operations S2061 and S2062.

At S2061, loss information is determined based on a preset loss function, the sample task execution result, and the task prediction result.

At S2062, if the loss information is less than a preset threshold, the initial interaction model is used as the target interaction model; or if the loss information is not less than the preset threshold, a parameter in the initial interaction model is adjusted, and the operation of processing the sample task and the sample interactive content by using an initial word processing unit in the initial interaction model, to obtain a corresponding word vector sequence is returned until the loss information is less than the preset threshold, and then the target interaction model is determined.

In some optional embodiments of the present application, if the type of the sample task is a task of specifying, based on interactive content with the questioner or the responder, second region information of an image region occupied by a target object corresponding to the interactive content in the sample image, the second region information of the image region occupied by the target object in the sample image is used to indicate coordinate ranges of a region occupied by the target object in the sample image.

Optionally, the target object corresponding to the interactive content is an object that is associated with the interactive content.

In the present application, the target interaction model includes: a target word processing unit, a target visual encoding unit, and a target transformation model.

Specifically, when the initial interaction model is trained as the target interaction model, the initial word processing unit is trained as the target word processing unit; the initial visual encoding unit is trained as the target visual encoding unit; and the initial transformation model is trained as the target transformation model.

Optionally, the inputting the first preset task, the first interactive content, and the environment image into the target interaction model, to obtain the task execution result corresponding to the first preset task includes:
performing word processing on the first preset task and the first interactive content by using a target word processing unit in a target interaction model, to obtain a corresponding word vector sequence;
encoding the environment image by using a target visual encoding unit in the target interaction model, to obtain an image feature sequence corresponding to the environment image; and
analyzing the word vector sequence and the image feature sequence by using a target transformation model in the target interaction model, to obtain a corresponding task execution result.

In some optional embodiments of the present application, if a task type of the sample task is a task of answering a question raised by a questioner based on a preset region in a sample image, the processing the sample task and the sample interactive content by using an initial word processing unit in an initial interaction model, to obtain a corresponding word vector sequence means: processing the sample task, region information of the preset region, and the sample interactive content by using the initial word processing unit in the initial interaction model, to obtain a corresponding word vector sequence.

The following uses a scenario diagram, FIG. 2b, to further describe the solution of the present application.

A user enters a voice instruction: “I'm thirsty. Get me something to drink.”

The intelligent robot detects whether the voice instruction is legal, and if yes, determines whether there is a beverage in the environment image, or if no, prompts the user to re-enter an instruction.

If there is a beverage in the environment image, a first preset task, first interactive content, and the environment image are analyzed by using a target interaction model, to obtain a task execution result corresponding to the first preset task. If there is no beverage in the environment image, the user is prompted that there is no beverage.

If the task execution result is yes, a second preset task is obtained, and the second preset task, the first interactive content, and the environment image are input into the target interaction model, to obtain first region information. An object in the first region information is used as the object to be grabbed in the environment image that corresponds to the instruction.

If the task execution result is no, a third preset task is obtained, and the third preset task, the first interactive content, and the environment image are input into the target interaction model, to obtain corresponding question content. The user is asked a question based on the question content. Second interactive content replied by the user based on the question content is obtained. The second interactive content and the question content are used as new first interactive content, and the operation of analyzing a first preset task, the first interactive content, and the environment image by using the target interaction model, to obtain a task execution result corresponding to the first preset task is returned until an object to be grabbed can be specified in the environment image.

The environment image and the first region information are input into a preset segmentation model, to obtain a mask corresponding to the environment image. The mask and depth image information corresponding to the environment image are input into a preset grabbing model, to obtain a target position.

A grabbing apparatus is controlled to grab a target item at the target position.

In a real machine experiment of multiple real household scenarios with ambiguity and unseen objects, the solution of the present application achieves a success rate of human-computer interaction grabbing of >85% (if there is no human-computer interaction, the success rate is 0% to 50%), and the effect is remarkable.

In the solution of obtaining an instruction from a user and an environment image, determining, based on the instruction, the environment image, and a preset target interaction model, an object to be grabbed in the environment image that corresponds to the instruction, and controlling a grabbing apparatus to grab a target item corresponding to the object to be grabbed, provided in the present disclosure, the environment image and the instruction can be analyzed in real time by using the preset target interaction model, and a new algorithm, i.e., the target interaction model, and the analysis of the environment image are introduced. Therefore, when an intelligent robot grabs an item, the intelligent robot can accurately identify a corresponding target item based on an instruction from a user, and the grabbing efficiency is high.

The solution of the present application enables an intelligent robot to understand more accurate and more robust complex visual relationships, human state behaviors, and complex user expressions in more open scenarios, facilitating the intelligent robot to naturally and accurately interact with a human and accurately understand and complete a language instruction of the human in most indoor and outdoor scenarios.

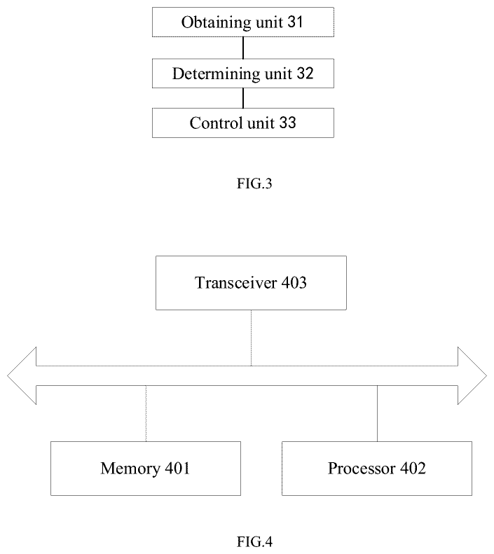

FIG. 3 is a schematic diagram of a structure of a data processing apparatus according to an exemplary embodiment of the present disclosure.

The apparatus includes:
an obtaining unit 31, configured to obtain an instruction from a user and an environment image;
a determining unit 32, configured to determine, based on the instruction, the environment image, and a preset target interaction model, an object to be grabbed in the environment image that corresponds to the instruction; and
a control unit 33, configured to control a grabbing apparatus to grab a target item corresponding to the object to be grabbed.

Optionally, when the foregoing apparatus is configured to control the grabbing apparatus to grab the target item corresponding to the object to be grabbed, the apparatus is specifically configured to:
control the grabbing apparatus to move to a target position where the target item corresponding to the object to be grabbed is located; and
control the grabbing apparatus to grab the target item at the target position.

Optionally, the instruction from the user is first interactive content of the user. When the foregoing apparatus is configured to determine, based on the instruction, the environment image, and a preset target interaction model, an object to be grabbed in the environment image that corresponds to the instruction, the apparatus is specifically configured to:
analyze a first preset task, the first interactive content, and the environment image by using the target interaction model, to obtain a task execution result corresponding to the first preset task, where the first preset task is a task of determining, based on the first interactive content, whether the object to be grabbed can be specified in the environment image; and
determine the object to be grabbed in the environment image that corresponds to the instruction based on the task execution result.

Optionally, when the foregoing apparatus is configured to determine, based on the task execution result, the object to be grabbed in the environment image that corresponds to the instruction, the apparatus is specifically configured to:
if the task execution result is yes, obtain a second preset task, where a task type of the second preset task is a task of specifying, based on the first interactive content, first region information of an image region occupied by the object to be grabbed in the environment image;
input the second preset task, the first interactive content, and the environment image into the target interaction model, to obtain the first region information; and
use an object in the first region information as the object to be grabbed in the environment image that corresponds to the instruction.

Optionally, the foregoing apparatus is further configured to:
if the task execution result is no, obtain a third preset task, where a task type of the third preset task is a task of asking a corresponding question based on the first interactive content;
input the third preset task, the first interactive content, and the environment image into the target interaction model, to obtain corresponding question content;
ask the user a question based on the question content;
obtain second interactive content replied by the user based on the question content; and
use the second interactive content and the question content as new first interactive content, and return to the operation of analyzing a first preset task, the first interactive content, and the environment image by using the target interaction model, to obtain a task execution result corresponding to the first preset task until an object to be grabbed can be specified in the environment image.

Optionally, the foregoing apparatus is further configured to:
detect, based on a preset detection model, whether the environment image contains an alternative object that is of a same category as an object corresponding to the first interactive content, and if yes, determine to perform the operation of analyzing a first preset task, the first interactive content, and the environment image by using the target interaction model, to obtain a task execution result corresponding to the first preset task.

Optionally, the foregoing apparatus is further configured to:
perform legality detection on the first interactive content, and if it is determined that the first interactive content is legal, determine to perform the operation of analyzing a first preset task, the first interactive content, and the environment image by using the target interaction model, to obtain a task execution result corresponding to the first preset task.

Optionally, the foregoing apparatus is further configured to:
input the environment image and the first region information into a preset segmentation model, to obtain a mask corresponding to the environment image; and
input the mask and depth image information corresponding to the environment image into a preset grabbing model, to obtain the target position.

Optionally, the foregoing apparatus is further configured to:
obtain a sample task;
obtain, based on a type of the sample task, corresponding sample interactive information and a sample image corresponding to the sample interactive information, wherein the sample interactive information includes: sample interactive content and a sample task execution result;
perform word processing on the sample task and the sample interactive content by using an initial word processing unit in an initial interaction model, to obtain a corresponding word vector sequence;
encode the sample image by using an initial visual encoding unit in the initial interaction model, to obtain an image feature sequence corresponding to the sample image;
analyze the word vector sequence and the image feature sequence by using an initial transformation model in the initial interaction model, to obtain a corresponding task prediction result; and
train the initial interaction model based on the sample task execution result and the task prediction result, to obtain the target interaction model.

It should be understood that the apparatus embodiment may correspond to the method embodiment, and similar descriptions may be referred to in the method embodiment. To avoid repetition, details are not described herein again. Specifically, the apparatus may perform the method in the foregoing method embodiment, and the foregoing and other operations and/or functions of each module in the apparatus are respectively used to implement corresponding processes in the foregoing methods of the method embodiment. For brevity, details are not described herein again.

The foregoing describes the apparatus of the embodiments of the present disclosure from the perspective of functional modules with reference to the accompanying drawings. It should be understood that the functional modules may be implemented in the form of hardware, or may be implemented by instructions in the form of software, or may be implemented by a combination of hardware and software modules. Specifically, each step in the method embodiment in the embodiments of the present disclosure may be completed by an integrated logic circuit of hardware in a processor and/or instructions in the form of software, and the steps of the method disclosed in the embodiments of the present disclosure may be directly embodied as being completed by a hardware decoding processor, or may be completed by a combination of hardware and software modules in the decoding processor. Optionally, the software module may be located in a mature storage medium in the art, such as a random access memory, a flash memory, a read-only memory, a programmable read-only memory, an electrically erasable programmable memory, or a register. The storage medium is located in a memory, and a processor reads information in the memory and completes the steps in the method embodiment according to the hardware of the processor.

FIG. 4 is a schematic block diagram of an electronic device according to an embodiment of the present disclosure. The electronic device may include:
a memory 401 and a processor 402, where the memory 401 is configured to store a computer program, and transmit program code to the processor 402. In other words, the processor 402 may call and run the computer program from the memory 401, to implement the method in the embodiments of the present disclosure.

For example, the processor 402 may be configured to perform the foregoing method embodiment according to an instruction in the computer program.

In some embodiments of the present disclosure, the processor 402 may include but is not limited to:
a general-purpose processor, a digital signal processor (Digital Signal Processor, DSP), an application specific integrated circuit (Application Specific Integrated Circuit, ASIC), a field programmable gate array (Field Programmable Gate Array, FPGA) or another programmable logic device, a discrete gate or transistor logic device, or a discrete hardware component.

In some embodiments of the present disclosure, the memory 401 includes but is not limited to:
a volatile memory and/or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which is used as an external cache. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (synch link DRAM, SLDRAM), and a direct rambus random access memory (Direct Rambus RAM, DR RAM).

In some embodiments of the present disclosure, the computer program may be divided into one or more modules. The one or more modules are stored in the memory 401, and are executed by the processor 402, to complete the method provided by the present disclosure. The one or more modules may be a series of computer program instruction segments that can complete specific functions. The instruction segments are used to describe an execution process of the computer program in the electronic device.

As shown in FIG. 4, the electronic device may further include:
a transceiver 403, where the transceiver 403 may be connected to the processor 402 or the memory 401.

The processor 402 may control the transceiver 403 to communicate with another device. Specifically, the processor 402 may send information or data to the another device, or receive information or data sent by the another device. The transceiver 403 may include a transmitter and a receiver. The transceiver 403 may further include one or more antennas.

It should be understood that components in the electronic device are connected to each other through a bus system. In addition to a data bus, the bus system further includes a power bus, a control bus, and a status signal bus.

The present disclosure further provides a computer storage medium having a computer program stored thereon, where the computer program, when executed by a computer, causes the computer to be able to perform the method in the foregoing method embodiment. Alternatively, an embodiment of the present disclosure further provides a computer program product including instructions, where the instructions, when executed by a computer, cause the computer to perform the method in the foregoing method embodiment.

When implemented in software, all or some of the embodiments may be implemented in the form of a computer program product. The computer program product includes one or more computer instructions. When the computer program instructions are loaded and executed on a computer, all or some of the processes or functions according to the embodiments of the present disclosure are generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, such as a server or a data center, including one or more usable media integrated. The usable medium may be a magnetic medium (for example, a floppy disk, a hard disk, or a magnetic tape), an optical medium (for example, a digital video disc (digital video disc, DVD)), or a semiconductor medium (for example, a solid-state drive (solid state disk, SSD)).

According to one or more embodiments of the present disclosure, a data processing method is provided. The method includes:
obtaining an instruction from a user and an environment image;
determining, based on the instruction, the environment image, and a preset target interaction model, an object to be grabbed in the environment image that corresponds to the instruction; and
controlling a grabbing apparatus to grab a target item corresponding to the object to be grabbed.

According to one or more embodiments of the present disclosure, the controlling a grabbing apparatus to grab a target item corresponding to the object to be grabbed includes:
controlling the grabbing apparatus to move to a target position where the target item corresponding to the object to be grabbed is located; and
controlling the grabbing apparatus to grab the target item at the target position.

According to one or more embodiments of the present disclosure, the instruction from the user is first interactive content of the user. The determining, based on the instruction, the environment image, and a preset target interaction model, an object to be grabbed in the environment image that corresponds to the instruction includes:
analyzing a first preset task, the first interactive content, and the environment image by using the target interaction model, to obtain a task execution result corresponding to the first preset task, where the first preset task is a task of determining, based on the first interactive content, whether the object to be grabbed can be specified in the environment image; and
determining the object to be grabbed in the environment image that corresponds to the instruction based on the task execution result.

According to one or more embodiments of the present disclosure, the determining the object to be grabbed in the environment image that corresponds to the instruction based on the task execution result includes:
if the task execution result is yes, obtaining a second preset task, where a task type of the second preset task is a task of specifying, based on the first interactive content, first region information of an image region occupied by the object to be grabbed in the environment image;
inputting the second preset task, the first interactive content, and the environment image into the target interaction model, to obtain the first region information; and
using an object in the first region information as the object to be grabbed in the environment image that corresponds to the instruction.

According to one or more embodiments of the present disclosure, the method further includes:
if the task execution result is no, obtaining a third preset task, where a task type of the third preset task is a task of asking a corresponding question based on the first interactive content;
inputting the third preset task, the first interactive content, and the environment image into the target interaction model, to obtain corresponding question content;
asking the user a question based on the question content;
obtaining second interactive content replied by the user based on the question content; and
using the second interactive content and the question content as new first interactive content, and returning to the operation of analyzing a first preset task, the first interactive content, and the environment image by using the target interaction model, to obtain a task execution result corresponding to the first preset task until an object to be grabbed can be specified in the environment image.

According to one or more embodiments of the present disclosure, the method further includes:
detecting, based on a preset detection model, whether the environment image contains an alternative object that is of a same category as an object corresponding to the first interactive content, and if yes, determining to perform the operation of analyzing a first preset task, the first interactive content, and the environment image by using the target interaction model, to obtain a task execution result corresponding to the first preset task.

According to one or more embodiments of the present disclosure, the method further includes:
performing legality detection on the first interactive content, and if it is determined that the first interactive content is legal, determining to perform the operation of analyzing a first preset task, the first interactive content, and the environment image by using the target interaction model, to obtain a task execution result corresponding to the first preset task.

According to one or more embodiments of the present disclosure, the method further includes:
inputting the environment image and the first region information into a preset segmentation model, to obtain a mask corresponding to the environment image; and
inputting the mask and depth image information corresponding to the environment image into a preset grabbing model, to obtain the target position.

According to one or more embodiments of the present disclosure, the method further includes:
obtaining a sample task;
obtaining, based on a type of the sample task, corresponding sample interactive information and a sample image corresponding to the sample interactive information, wherein the sample interactive information includes: sample interactive content and a sample task execution result;
performing word processing on the sample task and the sample interactive content by using an initial word processing unit in an initial interaction model, to obtain a corresponding word vector sequence;
encoding the sample image by using an initial visual encoding unit in the initial interaction model, to obtain an image feature sequence corresponding to the sample image;
analyzing the word vector sequence and the image feature sequence by using an initial transformation model in the initial interaction model, to obtain a corresponding task prediction result; and
training the initial interaction model based on the sample task execution result and the task prediction result, to obtain the target interaction model.

According to one or more embodiments of the present disclosure, a data processing apparatus is provided. The apparatus includes:
an obtaining unit, configured to obtain an instruction from a user and an environment image;
a determining unit, configured to determine, based on the instruction, the environment image, and a preset target interaction model, an object to be grabbed in the environment image that corresponds to the instruction; and
a control unit, configured to control a grabbing apparatus to grab a target item corresponding to the object to be grabbed.

According to one or more embodiments of the present disclosure, when the foregoing apparatus is configured to control the grabbing apparatus to grab the target item corresponding to the object to be grabbed, the apparatus is specifically configured to:
control the grabbing apparatus to move to a target position where the target item corresponding to the object to be grabbed is located; and
control the grabbing apparatus to grab the target item at the target position.

According to one or more embodiments of the present disclosure, the instruction from the user is first interactive content of the user. When the foregoing apparatus is configured to determine, based on the instruction, the environment image, and a preset target interaction model, an object to be grabbed in the environment image that corresponds to the instruction, the apparatus is specifically configured to:
analyze a first preset task, the first interactive content, and the environment image by using the target interaction model, to obtain a task execution result corresponding to the first preset task, where the first preset task is a task of determining, based on the first interactive content, whether the object to be grabbed can be specified in the environment image; and
determine the object to be grabbed in the environment image that corresponds to the instruction based on the task execution result.

According to one or more embodiments of the present disclosure, when the foregoing apparatus is configured to determine, based on the task execution result, the object to be grabbed in the environment image that corresponds to the instruction, the apparatus is specifically configured to:
if the task execution result is yes, obtain a second preset task, where a task type of the second preset task is a task of specifying, based on the first interactive content, first region information of an image region occupied by the object to be grabbed in the environment image;
input the second preset task, the first interactive content, and the environment image into the target interaction model, to obtain the first region information; and
use an object in the first region information as the object to be grabbed in the environment image that corresponds to the instruction.

According to one or more embodiments of the present disclosure, the foregoing apparatus is further configured to:
if the task execution result is no, obtain a third preset task, where a task type of the third preset task is a task of asking a corresponding question based on the first interactive content;
input the third preset task, the first interactive content, and the environment image into the target interaction model, to obtain corresponding question content;
ask the user a question based on the question content;
obtain second interactive content replied by the user based on the question content; and
use the second interactive content and the question content as new first interactive content, and return to the operation of analyzing a first preset task, the first interactive content, and the environment image by using the target interaction model, to obtain a task execution result corresponding to the first preset task until an object to be grabbed can be specified in the environment image.

According to one or more embodiments of the present disclosure, the foregoing apparatus is further configured to:
detect, based on a preset detection model, whether the environment image contains an alternative object that is of a same category as an object corresponding to the first interactive content, and if yes, determine to perform the operation of analyzing a first preset task, the first interactive content, and the environment image by using the target interaction model, to obtain a task execution result corresponding to the first preset task.

According to one or more embodiments of the present disclosure, the foregoing apparatus is further configured to:
perform legality detection on the first interactive content, and if it is determined that the first interactive content is legal, determine to perform the operation of analyzing a first preset task, the first interactive content, and the environment image by using the target interaction model, to obtain a task execution result corresponding to the first preset task.

According to one or more embodiments of the present disclosure, the foregoing apparatus is further configured to:
input the environment image and the first region information into a preset segmentation model, to obtain a mask corresponding to the environment image; and
input the mask and depth image information corresponding to the environment image into a preset grabbing model, to obtain the target position.

According to one or more embodiments of the present disclosure, the foregoing apparatus is further configured to:
obtain a sample task;
obtain, based on a type of the sample task, corresponding sample interactive information and a sample image corresponding to the sample interactive information, wherein the sample interactive information includes: sample interactive content and a sample task execution result;
perform word processing on the sample task and the sample interactive content by using an initial word processing unit in an initial interaction model, to obtain a corresponding word vector sequence;
encode the sample image by using an initial visual encoding unit in the initial interaction model, to obtain an image feature sequence corresponding to the sample image;
analyze the word vector sequence and the image feature sequence by using an initial transformation model in the initial interaction model, to obtain a corresponding task prediction result; and
train the initial interaction model based on the sample task execution result and the task prediction result, to obtain the target interaction model.

According to one or more embodiments of the present disclosure, an electronic device is provided. The electronic device includes:
a processor; and
a memory, configured to store executable instructions of the processor,
wherein the processor is configured to perform the foregoing methods by executing the executable instructions.

According to one or more embodiments of the present disclosure, a computer-readable storage medium is provided. A computer program is stored on the computer-readable storage medium. When the computer program is executed by a processor, the foregoing methods are implemented.

Persons of ordinary skill in the art may be aware that the modules and algorithm steps of the examples described with reference to the embodiments disclosed herein may be implemented in electronic hardware or a combination of computer software and electronic hardware. Whether these functions are performed in hardware or software depends on specific applications and design constraint conditions of the technical solutions. Persons skilled in the art may implement the described functions using different methods for each specific application, but such implementation should not be considered as going beyond the scope of the present disclosure.

In the several embodiments provided in the present disclosure, it should be understood that the disclosed system, apparatus, and method may be implemented in other manners. For example, the described apparatus embodiment is merely an example. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electrical, mechanical or other forms.

Modules described as separate parts may or may not be physically separate, and parts displayed as modules may or may not be physical modules, and may be located at one position, or may be distributed on a plurality of network units. Some or all of the modules may be selected based on actual needs to achieve the objectives of the solutions of the embodiments. For example, the functional modules in the embodiments of the present disclosure may be integrated into one processing module, each of the modules may exist alone physically, or two or more modules may be integrated into one module.

The foregoing descriptions are merely specific implementations of the present disclosure, but are not intended to limit the scope of protection of the present disclosure. Any variation or replacement readily figured out by a person skilled in the art within the technical scope disclosed in the present disclosure shall fall within the scope of protection of the present disclosure. Therefore, the scope of protection of the present disclosure shall be subject to the scope of protection of the claims.

What is claimed is:

1. A data processing method, the method comprising:
obtaining an instruction from a user and an environment image;
determining, based on the instruction, the environment image and a preset target interaction model, an object to be grabbed in the environment image that corresponds to the instruction; and
controlling a grabbing apparatus to grab a target item corresponding to the object to be grabbed.

2. The method according to claim 1, wherein controlling the grabbing apparatus to grab the target item corresponding to the object to be grabbed comprises:
controlling the grabbing apparatus to move to a target position where the target item corresponding to the object to be grabbed is located; and
controlling the grabbing apparatus to grab the target item at the target position.

3. The method according to claim 1, wherein the instruction from the user is first interactive content of the user, and the determining, based on the instruction, the environment image and a preset target interaction model, an object to be grabbed in the environment image that corresponds to the instruction comprises:
analyzing a first preset task, the first interactive content and the environment image by using the target interaction model, to obtain a task execution result corresponding to the first preset task, wherein the first preset task is a task of determining, based on the first interactive content, whether the object to be grabbed can be specified in the environment image; and
determining, based on the task execution result, the object to be grabbed in the environment image that corresponds to the instruction.

4. The method according to claim 3, wherein the determining, based on the task execution result, the object to be grabbed in the environment image that corresponds to the instruction comprises:
in response to the task execution result being yes, obtaining a second preset task, wherein a task type of the second preset task is a task of specifying, based on the first interactive content, first region information of an image region occupied by the object to be grabbed in the environment image;
inputting the second preset task, the first interactive content and the environment image into the target interaction model, to obtain the first region information; and
using an object in the first region information as the object to be grabbed in the environment image that corresponds to the instruction.

5. The method according to claim 3, wherein the method further comprises:
in response to the task execution result being no, obtaining a third preset task, wherein a task type of the third preset task is a task of asking a corresponding question based on the first interactive content;
inputting the third preset task, the first interactive content and the environment image into the target interaction model, to obtain corresponding question content;
asking the user a question based on the question content;
obtaining second interactive content replied by the user based on the question content; and
using the second interactive content and the question content as new first interactive content, and returning to the operation of analyzing a first preset task, the first interactive content and the environment image by using the target interaction model, to obtain a task execution result corresponding to the first preset task, until an object to be grabbed can be specified in the environment image.

6. The method according to claim 3, wherein the method further comprises:
detecting, based on a preset detection model, whether the environment image contains an alternative object that is of a same category as an object corresponding to the first interactive content, and in response to yes, determining to perform the operation of analyzing a first preset task, the first interactive content and the environment image by using the target interaction model, to obtain a task execution result corresponding to the first preset task.

7. The method according to claim 3, wherein the method further comprises:
performing legality detection on the first interactive content, and in response to it being determined that the first interactive content is legal, determining to perform the operation of analyzing a first preset task, the first interactive content and the environment image by using the target interaction model, to obtain a task execution result corresponding to the first preset task.

8. The method according to claim 4, wherein the method further comprises:
inputting the environment image and the first region information into a preset segmentation model, to obtain a mask corresponding to the environment image; and
inputting the mask and depth image information corresponding to the environment image into a preset grabbing model, to obtain the target position.

9. The method according to claim 1, wherein the method further comprises:
obtaining a sample task;
obtaining, based on a type of the sample task, corresponding sample interactive information and a sample image corresponding to the sample interactive information, wherein the sample interactive information comprises: sample interactive content and a sample task execution result;
performing word processing on the sample task and the sample interactive content by using an initial word processing unit in an initial interaction model, to obtain a corresponding word vector sequence;
encoding the sample image by using an initial visual encoding unit in the initial interaction model, to obtain an image feature sequence corresponding to the sample image;
analyzing the word vector sequence and the image feature sequence by using an initial transformation model in the initial interaction model, to obtain a corresponding task prediction result; and
training the initial interaction model based on the sample task execution result and the task prediction result, to obtain the target interaction model.

10. An electronic device, comprising:
a processor; and
a memory, configured to store executable instructions of the processor,
wherein the processor is configured to execute the following operations by executing the executable instructions:
obtaining an instruction from a user and an environment image;
determining, based on the instruction, the environment image and a preset target interaction model, an object to be grabbed in the environment image that corresponds to the instruction; and
controlling a grabbing apparatus to grab a target item corresponding to the object to be grabbed.

11. The electronic device according to claim 10, wherein controlling the grabbing apparatus to grab the target item corresponding to the object to be grabbed comprises:
controlling the grabbing apparatus to move to a target position where the target item corresponding to the object to be grabbed is located; and
controlling the grabbing apparatus to grab the target item at the target position.

12. The electronic device according to claim 10, wherein the instruction from the user is first interactive content of the user, and the determining, based on the instruction, the environment image and a preset target interaction model, an object to be grabbed in the environment image that corresponds to the instruction comprises:
analyzing a first preset task, the first interactive content and the environment image by using the target interaction model, to obtain a task execution result corresponding to the first preset task, wherein the first preset task is a task of determining, based on the first interactive content, whether the object to be grabbed can be specified in the environment image; and
determining, based on the task execution result, the object to be grabbed in the environment image that corresponds to the instruction.

13. The electronic device according to claim 12, wherein the determining, based on the task execution result, the object to be grabbed in the environment image that corresponds to the instruction comprises:
in response to the task execution result being yes, obtaining a second preset task, wherein a task type of the second preset task is a task of specifying, based on the first interactive content, first region information of an image region occupied by the object to be grabbed in the environment image;
inputting the second preset task, the first interactive content and the environment image into the target interaction model, to obtain the first region information; and
using an object in the first region information as the object to be grabbed in the environment image that corresponds to the instruction.

14. The electronic device according to claim 12, wherein the processor is further configured to execute the following operations by executing the executable instructions:
in response to the task execution result being no, obtaining a third preset task, wherein a task type of the third preset task is a task of asking a corresponding question based on the first interactive content;
inputting the third preset task, the first interactive content and the environment image into the target interaction model, to obtain corresponding question content;
asking the user a question based on the question content;
obtaining second interactive content replied by the user based on the question content; and
using the second interactive content and the question content as new first interactive content, and returning to the operation of analyzing a first preset task, the first interactive content and the environment image by using the target interaction model, to obtain a task execution result corresponding to the first preset task, until an object to be grabbed can be specified in the environment image.

15. The electronic device according to claim 12, wherein the processor is further configured to execute the following operations by executing the executable instructions:
detecting, based on a preset detection model, whether the environment image contains an alternative object that is of a same category as an object corresponding to the first interactive content, and in response to yes, determining to perform the operation of analyzing a first preset task, the first interactive content and the environment image by using the target interaction model, to obtain a task execution result corresponding to the first preset task.

16. A non-transitory computer-readable storage medium, having a computer program stored thereon, wherein when the computer program is executed by a processor, the following operations are implemented:
obtaining an instruction from a user and an environment image;
determining, based on the instruction, the environment image and a preset target interaction model, an object to be grabbed in the environment image that corresponds to the instruction; and
controlling a grabbing apparatus to grab a target item corresponding to the object to be grabbed.

17. The non-transitory computer-readable storage medium according to claim 16, wherein controlling the grabbing apparatus to grab the target item corresponding to the object to be grabbed comprises:
controlling the grabbing apparatus to move to a target position where the target item corresponding to the object to be grabbed is located; and
controlling the grabbing apparatus to grab the target item at the target position.

18. The non-transitory computer-readable storage medium according to claim 16, wherein the instruction from the user is first interactive content of the user, and the determining, based on the instruction, the environment image and a preset target interaction model, an object to be grabbed in the environment image that corresponds to the instruction comprises:
analyzing a first preset task, the first interactive content and the environment image by using the target interaction model, to obtain a task execution result corresponding to the first preset task, wherein the first preset task is a task of determining, based on the first interactive content, whether the object to be grabbed can be specified in the environment image; and
determining, based on the task execution result, the object to be grabbed in the environment image that corresponds to the instruction.

19. The non-transitory computer-readable storage medium according to claim 18, wherein the determining, based on the task execution result, the object to be grabbed in the environment image that corresponds to the instruction comprises:
in response to the task execution result being yes, obtaining a second preset task, wherein a task type of the second preset task is a task of specifying, based on the first interactive content, first region information of an image region occupied by the object to be grabbed in the environment image;
inputting the second preset task, the first interactive content and the environment image into the target interaction model, to obtain the first region information; and
using an object in the first region information as the object to be grabbed in the environment image that corresponds to the instruction.

20. The non-transitory computer-readable storage medium according to claim 18, wherein when the computer program is executed by a processor, the following operations are further implemented:
in response to the task execution result being no, obtaining a third preset task, wherein a task type of the third preset task is a task of asking a corresponding question based on the first interactive content;
inputting the third preset task, the first interactive content and the environment image into the target interaction model, to obtain corresponding question content;
asking the user a question based on the question content;
obtaining second interactive content replied by the user based on the question content; and
using the second interactive content and the question content as new first interactive content, and returning to the operation of analyzing a first preset task, the first interactive content and the environment image by using the target interaction model, to obtain a task execution result corresponding to the first preset task, until an object to be grabbed can be specified in the environment image.
